(19) United States
(12) Patent Application Publication
(10) Pub. No.: US 2020/0231807 A1
(43) Pub. Date: Jul. 23, 2020

(54) HIGH FLOW POLYMER COMPOSITIONS

(71) Applicant: SOLVAY SPECIALTY POLYMERS USA, LLC, Alpharetta, GA (US)

(72) Inventors: Narmandakh TAYLOR, Chicago, IL (US); Stéphane JEOL, Cumming, GA (US); Christopher WARD, Sandy Springs, GA (US); Vito LEO, Glimes (Incourt) (BE)

(21) Appl. No.: 16/634,176

(22) PCT Filed: Jul. 5, 2018
(86) PCT No.: PCT/EP2018/068314

§ 371 Date: Jan. 27, 2020

Related U.S. Application Data
(60) Provisional application No. 62/540,289, filed on Aug. 2, 2017.

(51) Int. Cl. C08L 81/06; C08L 71/00; B29C 64/153; B29C 64/118; C08K 7/14

(52) U.S. Cl. CPC C08L 81/06; C08L 71/00; B29K 2071/00; B29C 64/118; C08K 7/14; B29C 64/153

(57) ABSTRACT

Disclosed is a polymer composition including a poly(ether ether ketone) (PEEK), a poly(aryl ether sulfone) (PAES) having a number average molecular weight (Mn)≤10,000 g/mol, and optionally a reinforcing filler, methods of making the polymer composition, shaped articles including the polymer composition, and methods of making the shaped articles.

### RELATED APPLICATIONS

This application claims priority to U.S. provisional application No. 62/540,289, filed on Aug. 2, 2017, the whole content of this application being incorporated herein by reference for all purposes.

### FIELD OF THE INVENTION

The present invention relates to a polymer composition including a poly(ether ether ketone) (PEEK), about 3 to about 30 wt. % of a poly(aryl ether sulfone) (PAES) having a number average molecular weight (Mn)≤10,000 g/mol, based on the total weight of the PEEK and the PAES, optionally a reinforcing filler, and optionally one or more additional additives. Also described are methods of making the polymer composition, shaped articles including the polymer composition, and methods of making the shaped articles.

### BACKGROUND

Polyetheretherketone (PEEK) is a semi-crystalline thermoplastic that is highly resistant to thermal degradation and exhibits excellent mechanical properties and chemical resistance, even at high temperatures. Nevertheless, a need exists for PEEK compositions that have improved melt flow, especially when including reinforcing filler.

Polymer compositions having high melt flow are advantageous in numerous applications and manufacturing techniques. For example, high melt flow polymers are necessary for injection molding of shaped articles with thin parts, in thermoplastic continuous fiber (glass, carbon, aramide) composites and in additive manufacturing methods where more viscous polymers would be unsuitable. In some such applications, such as, for example, structural components for mobile electronic devices, it may be necessary to produce thin structures having a thickness less than 10 mm, less than 5 mm, less than 3 mm, or even less than 1 mm. Moreover, in additive manufacturing methods such as selective laser sintering (SLS) and fused filament fabrication (FFF), high melt flow is essential for adequate deposition and spreading of successive layers of polymer in the printing process.

Conventionally, the melt viscosity of PEEK has been reduced by decreasing the molecular weight of the PEEK; however, this inevitably results in a reduction in mechanical properties. Accordingly, a need exists for PEEK-based compositions having reduced melt viscosity without significantly diminishing its advantageous mechanical properties.

### DETAILED DESCRIPTION OF PREFERRED EMBODIMENTS

Described herein are polymer compositions including PEEK, about 3 to about 30 wt. % of a PAES having a number average molecular weight (Mn)≤10,000 g/mol, based on the total weight of the of the PEEK and the PAES, optionally one or more reinforcing fillers, and optionally one or more additional additives. Also described are methods of making the polymer composition, shaped articles including the polymer composition, and methods of making the shaped articles.

Applicants surprisingly discovered that polymer compositions including PEEK and a PAES of the present invention having a number average molecular weight (Mn)≤10,000 g/mol exhibit reduced melt viscosity without compromising—and in some cases actually increasing-mechanical properties (for example, modulus of elasticity, tensile strength a break, and tensile elongation at break) as compared with blends of PEEK and PAES having a higher molecular weight.

The polymer composition includes at least PEEK and a PAES having a number average molecular weight (Mn)≤10,000 g/mol, where the weight ratio PEEK/PAES ranges from 97/3 to 70/30 preferably from 95/5 to 80/20, even more preferably from 92/8 to 85/15.

In some embodiments, the polymer composition includes one or more thermoplastic polymers in addition to the PEEK and the PAES having a number average molecular weight (Mn)≤10,000 g/mol.

### Poly(Ether Ether Ketone) (PEEK)

As used herein, a “poly(ether ether ketone) (PEEK)” denotes any polymer of which at least 50 mol % of recurring units (R_{PEEK}) are recurring units of formula:

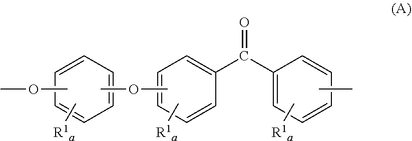

based on the total number of moles of recurring units in the poly(ether ether ketone) (PEEK), where:
each R¹, equal or different from each other, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
each a, equal to or different from each other, is independently selected from 0, 1, 2, 3, and 4. Preferably, each a is 0.

Preferably at least 60 mol %, at least 70 mol %, at least 80 mol %, at least 90 mol %, at least 95 mol %, or at least 99 mol % of recurring units (R_{PEEK}) are recurring units of formula (A).

Preferably, the phenylene moieties in recurring units (R_{PEEK}) have 1,3- or 1,4-linkages.

In some embodiments, the more than 50 mol % of recurring units (R_{PEEK}) are recurring units of formula:

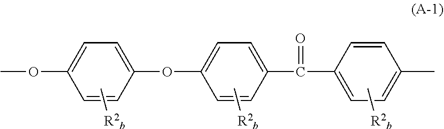

where each R² and b, at each instance, is independently selected from the groups described above for R¹ and a, respectively. b in formulae (A-1) is an integer ranging from 0 to 4, preferably 0.

Preferably at least 60 mol %, at least 70 mol %, at least 80 mol %, at least 90 mol %, at least 95 mol % or at least 99 mol % of recurring units (R_{PEEK}) are recurring units of formula (A-1).

The amount of PEEK the polymer composition ranges from 97 to 70 wt. %, preferably from 95 to 80 wt. %, even more preferably from 92 to 85 wt. %, based on the total weight of the PEEK and the PAES having a number average molecular weight (Mn)≤10,000 g/mol.

In some embodiments, the polymer composition includes from about 50 to about 97 wt. %, preferably from about 80 to about 95 wt. % of PEEK, based on the total weight of the polymer composition. In some embodiments the polymer composition includes from about 55 to about 65 wt. % of PEEK, based on the total weight of the polymer composition.

### Poly(Aryl Ether Sulfone) (PAES) of the Invention

As used herein, a “poly(aryl ether sulfone) (PAES)” denotes any polymer of which at least 50 mol % of the recurring units are recurring units (R_{PAES}) of formula:

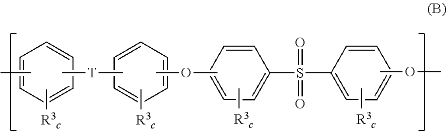

where:
each R³, equal to or different from each other, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each c, equal to or different from each other, is independently selected from 0, 1, 2, 3, and 4, preferably 0; and
T is selected from the group consisting of a bond, a sulfone group [—S(═O)₂—], and a group —C(R⁴)(R⁵)—, where R⁴ and R⁵, equal to or different from each other, is independently selected from a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium. R⁴ and R⁵ are preferably methyl groups.

Preferably at least 60 mol %, at least 70 mol %, 80 mol %, 90 mol %, 95 mol %, 99 mol % of recurring units (R_{PAES}) are recurring units of formula (B).

In some embodiments, the PAES is a polyphenylsulfone (PPSU). As used herein, a “polyphenylsulfone (PPSU)” denotes any polymer of which more than 50 mol % of the recurring units (R_{PAES}) are recurring units of formula:

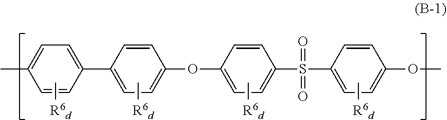

where each R⁶ and d, at each instance, is independently selected from the groups described above for R³ and c, respectively. Preferably each d in formulae (B-1) is zero.

Preferably at least 60 mol %, at least 70 mol %, 80 mol %, 90 mol %, 95 mol %, 99 mol % of recurring units (R_{PAES}) are recurring units of formula (B-1).

In some embodiments, the PAES is a polyethersulfone (PES). As used herein, a “polyethersulfone (PES)” denotes any polymer of which at least 50 mol % of the recurring units (R_{PAES}) are recurring units of formula:

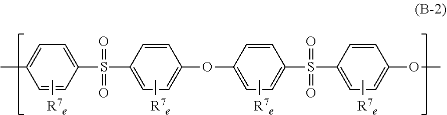

where each R⁷ and e, at each instance, is independently selected from the groups described above for R³ and c, respectively. Preferably each e in formulae (B-2) is zero.

Preferably at least 60 mol %, at least 70 mol %, 80 mol %, 90 mol %, 95 mol %, 99 mol % of recurring units (R_{PAES}) are recurring units of formula (B-2).

In some embodiments, the PAES is a polysulfone (PSU). As used herein, a “polysulfone (PSU)” denotes any polymer of which at least 50 mol % of the recurring units (R_{PAES}) are recurring units of formula:

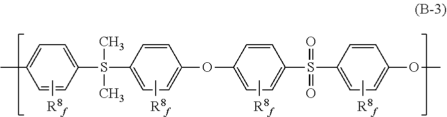

where each R⁸ and f, at each instance, is independently selected from the groups described above for R³ and c, respectively. Preferably each f in formulae (B-3) is zero.

Preferably at least 60 mol %, at least 70 mol %, 80 mol %, 90 mol %, 95 mol %, 99 mol % of recurring units (R_{PAES}) are recurring units of formula (B-3).

Preferably the PAES is selected from the group consisting of PPSU, PES, PSU, and a combination thereof. In some embodiments, the PAES is selected from the group consisting of PPSU, PSU, and combinations thereof. Most preferably, the PAES is PPSU.

The amount of PAES having a number average molecular weight (Mn)≤10,000 g/mol in the polymer composition preferably ranges from about 3 to about 30 wt. %, preferably from about 3 to about 20 wt. %, preferably from about 5 to about 20 wt. %, preferably from about 5 to about 15 wt. %, preferably from about 8 to about 15 wt. % based on the total weight of the PEEK and the PAES having a number average molecular weight (Mn)≤10,000 g/mol. In some embodiments, the amount of PAES having a number average molecular weight (Mn)≤10,000 g/mol in the polymer composition ranges from about 5 to about 10 wt. %, based on the total weight of the PEEK and the PAES having a number average molecular weight (Mn)≤10,000 g/mol.

The number average molecular weight (Mn) of the PAES is less than 10,000 g/mol, preferably less than 9,000 g/mol, preferably less than 8,000 g/mol. In some embodiments, the number average molecular weight (Mn) of the PAES is less than 7,000 g/mol, preferably less than 6,000 g/mol.

In some aspects, the number average molecular weight (Mn) of the PAES ranges from about 1,000 to 10,000 g/mol, preferably from about 2,000 to about 9,000 g/mol, preferably from about 3,000 to about 8,000 g/mol, preferably from about 4,000 to about 8,000 g/mol, most preferably from about 5,000 to about 8,000 g/mol.

As used herein, the “number average molecular weight (Mn)” means the molecular weight as calculated by the following formula:

$$Mn = \frac{2 , 000 , 000}{{\sum }_{i} [ {EG}_{i} ]}$$

where [EGi] corresponds to the concentration of end groups (also called a chain ends) of the PAES in μmol/g.

The end groups are moieties at respective ends of the PAES polymer chain that are used to assess the number average molecular weight (Mn) of the PAES polymer—in particular, by measuring the concentration of the end groups to determine the number of moles of PAES in a given weight of sample.

Depending on the method used for making the PAES, and the possible use of an end-capping agent during the process, the PAES may possess, for example, end-groups derived from the monomers and/or from end-capping agents. Frequently, PAES is manufactured by a polycondensation reaction between dihalo- and dihydroxyl-derivatives and/or halo-hydroxy derivatives, so that the end groups generally include hydroxyl groups and halo-groups (such as chlorinated end groups or fluorinated end groups); however, when an end-capping agent is used, the remaining hydroxyl groups may be at least partially converted into alkoxy (e.g. methoxy) or aryloxy end groups.

The concentration of hydroxyl groups can be determined by titration, the concentration of alkoxy or aryloxy groups can be determined by NMR with a C₂D₂C₄ solvent, and the concentration of halogen groups can be determined with a halogen analyzer as described below in the Examples. Nevertheless, any suitable method may be used to determine the concentration of the end groups. For example, titration, NMR, or a halogen analyzer may be used.

### Optional Reinforcing Fillers

The polymeric layer may optionally include reinforcing fillers such as fibrous or particulate fillers. A fibrous reinforcing filler is a material having length, width and thickness, wherein the average length is significantly larger than both the width and thickness. Preferably, such a material has an aspect ratio, defined as the average ratio between the length and the smallest of the width and thickness of at least 5. Preferably, the aspect ratio of the reinforcing fibers is at least 10, more preferably at least 20, still more preferably at least 50. The particulate fillers have an aspect ratio of at most 5, preferably at most 2.

Preferably, the reinforcing filler is selected from mineral fillers, such as talc, mica, kaolin, calcium carbonate, calcium silicate, magnesium carbonate; glass fibers; carbon fibers, boron carbide fibers; wollastonite; silicon carbide fibers; boron fibers, graphene, carbon nanotubes (CNT), and the like. Most preferably, the reinforcing filler is glass fiber, preferably chopped glass fiber, or carbon fiber, preferably chopped carbon fibers.

The amount of the reinforcing filler may range in the case of particulate fillers, from 1 wt. % to 40 wt. %, preferably from 5 wt. % to 35 wt. % and most preferably from 10 wt. % to 30 wt. %, and in the case of fibrous fillers from 5 wt. % to 50 wt. %, preferably from 10 wt. % to 40 wt. %, and most preferably from 15 wt. % to 30 wt. % based on the total weight of the polymer composition. Preferably, the polymer composition includes about 25 to about 35 wt. %, most preferably about 30 wt. %, of glass or carbon fiber, most preferably glass fiber. In some embodiments, the polymer composition is free of a fibrous filler. Alternatively the polymer layer may be free of a particulate filler.

### Optional Additives

In addition to the PEEK, PAES, and the optional reinforcing filler, the polymer composition may further include optional additives such as titanium dioxide, zinc sulfide, zinc oxide, ultraviolet light stabilizers, heat stabilizers, antioxidants such as organic phosphites and phosphonites, acid scavengers, processing aids, nucleating agents, lubricants, flame retardants, a smoke-suppressing agents, anti-static agents, anti-blocking agents, and conductivity additives such as carbon black.

In some embodiments, the polymer composition is free of a viscosity modifier.

When one or more optional additives are present, their total concentration is preferably less than 10 wt. %, more preferably less than 5 wt. %, and most preferably less than 2 wt. %, based on the total weight of polymer composition.

Methods of Making the Polymer Composition Exemplary embodiments also include methods of making the polymer composition.

The polymer composition can be made by methods well known to the person of skill in the art. For example, such methods include, but are not limited to, melt-mixing processes. Melt-mixing processes are typically carried out by heating the polymer components above the melting temperature of the thermoplastic polymers thereby forming a melt of the thermoplastic polymers. In some embodiments, the processing temperature ranges from about 280-450° C., preferably from about 290-440° C., from about 300-430° C. or from about 310-420° C. Suitable melt-mixing apparatus are, for example, kneaders, Banbury mixers, single-screw extruders, and twin-screw extruders.

Preferably, use is made of an extruder fitted with means for dosing all the desired components to the extruder, either to the extruder's throat or to the melt. In the process for the preparation of the part material, the components of the polymer composition, i.e. the PEEK, the PPSU, the optional reinforcing filler, and optional additives, are fed to the melt-mixing apparatus and melt-mixed in that apparatus. The components may be fed simultaneously as a powder mixture or granule mixer, also known as dry-blend, or may be fed separately.

The order of combining the components during melt-mixing is not particularly limited. In one embodiment, the component can be mixed in a single batch, such that the desired amounts of each component are added together and subsequently mixed. In other embodiments, a first sub-set of components can be initially mixed together and one or more of the remaining components can be added to the mixture for further mixing. For clarity, the total desired amount of each component does not have to be mixed as a single quantity. For example, for one or more of the components, a partial quantity can be initially added and mixed and, subsequently, some or all of the remainder can be added and mixed.

### Shaped Articles and Methods of Making

Exemplary embodiments also include shaped articles comprising the above-described polymer composition and methods of making the shaped articles.

The polymer composition may be well suited for the manufacture of articles useful in a wide variety of applications. For example, the high-flow, toughness, and chemical resistance properties of the polymer composition makes it especially suitable for use in thin walled articles, structural components for mobile electronic devices (e.g., framework or housing), thermoplastic continuous fiber composites (e.g. for aeronautics and automotive structural parts), medical implants and medical devices, and shaped articles made by additive manufacturing methods as discussed below.

In some aspects, the shaped articles may be made from the polymer composition using any suitable melt-processing method such as injection molding, extrusion molding, roto-molding, or blow-molding.

Exemplary embodiments are also directed to methods of making shaped articles by additive manufacturing, where the shaped article is printed from the polymer composition. The methods include printing layers of the shaped article from the polymer composition as described below.

Additive manufacturing systems are used to print or otherwise build a shaped object from a digital representation of the shaped object by one or more additive manufacturing techniques. Examples of commercially available additive manufacturing techniques include extrusion-based techniques, selective laser sintering, powder/binder jetting, electron-beam melting, and stereolithography processes. For each of these techniques, the digital representation of the shaped object is initially sliced into multiple horizontal layers. For each layer, a tool path is then generated, which provides instructions for the particular additive manufacturing system to print the given layer.

For example, in an extrusion-based additive manufacturing system, a shaped article may be printed from a digital representation of the shaped article in a layer-by-layer manner by extruding and adjoining strips of the polymer composition. The polymer composition is extruded through an extrusion tip carried by a print head of the system, and is deposited as a sequence of roads on a platen in an x-y plane. The extruded material fuses to previously deposited material and solidifies as it cools. The position of the print head relative to the substrate is then incremented along a z-axis (perpendicular to the x-y plane), and the process is repeated to form a shaped article resembling the digital representation. An example of an extrusion-based additive manufacturing system is Fused Filament Fabrication (FFF).

As another example, in a powder-based additive manufacturing system, a laser is used to locally sinter powder into a solid part. A shaped article is created by sequentially depositing a layer of powder followed by a laser pattern to sinter an image onto that layer. An example of a powder-based additive manufacturing system is Selective Laser Sintering (SLS).

As another example, carbon-fiber composite shaped articles can be prepared using a continuous Fiber-Reinforced Thermosplastic (FRTP) printing method. This method is based on fused-deposition modeling (FDM) and prints a combination of fibers and resin.

The flowability of the resin is particularly important in additive manufacturing applications where, for example, the polymer must flow readily from printing nozzles and must spread quickly and evenly to produce a uniform surface before cooling; however it is also important that the flowability needed for printing not come at the significant expense of mechanical properties of the resin in the resulting printed object.

As discussed above, Applicants surprisingly discovered that polymer compositions including PEEK and a PAES having a number average molecular weight (Mn)≤10,000 g/mol exhibit reduced melt viscosity without significant reduction in mechanical properties as compared with blends of PEEK and PAES having a higher molecular weight, making such polymer compositions particularly suitable for additive manufacturing applications.

Accordingly, some embodiments include a method of making a shaped article comprising printing layers of the polymer composition to form the shaped article by an extrusion-based additive manufacturing system (for example FFF), a powder-based additive manufacturing system (for example SLS), or a continuous Fiber-Reinforced Thermosplastic (FRTP) printing method.

Some embodiments include a filament including the polymer composition. Preferably, the filament is suitable for use in additive manufacturing methods as described above, such as FFF.

The term “filament” refers to a thread-like object or fiber including the polymer composition. The filament may have a cylindrical or substantially cylindrical geometry, or may have a non-cylindrical geometry, such as a ribbon-shaped filament. The filament may be hollow, or may have a core-shell geometry, with a different polymer composition comprising either the core or the shell.

When the filament has a cylindrical geometry, the diameter of the cross-section of the fiber preferably ranges from 0.5 to 5 mm, preferably from 0.8 to 4 mm, preferably from 1 mm to 3.5 mm. The diameter of the filament can be chosen to feed a specific FFF 3D printer. An example of filament diameter used extensively in FFF processes is about 1.75 mm or about 2.85 mm. The filament is preferably made by extruding the polymer composition.

According to some embodiments, the polymer composition is in the form of microparticles or a powder, for example having an average diameter ranging from 1 to 200 μm, preferably from 10 to 100 μm, preferably from 20 to 80 μm as measured by electron microscopy.

Exemplary embodiments also include shaped articles made, at least in part, by the additive manufacturing methods described above using the polymer composition described above. Such shaped articles can be used in a variety of final applications such as implantable medical devices, dental prostheses, and brackets and complex shaped parts in the aerospace and automotive industries.

Should the disclosure of any patents, patent applications, and publications which are incorporated herein by reference conflict with the description of the present application to the extent that it may render a term unclear, the present description shall take precedence.

Exemplary embodiments will now be described in the following non-limiting examples.

### EXAMPLES

The effects on melt viscosity and mechanical properties were evaluated for various blends of PEEK and PAES having a number average molecular weight (Mn)≤10,000 g/mol in different proportions. In each case, a comparison made to respective blends of PEEK and PAESs having higher molecular weights. The compositions and results for glass-filled PEEK/PPSU blends are shown in Table 2. The compositions and results for glass-filled PEEK/PES blends are shown in Table 3. The compositions and results for glass-filled PEEK/PSU blends are shown in Table 4, and compositions and results for unfilled PEEK/PPSU blends follows in Table 5.

### Materials

The following materials were used in the Examples and Comparative Examples:

KetaSpire® PEEK KT-880 and KT-820 available from Solvay Specialty Polymers USA, L.L.C.

Radel® PPSU R-5600 NT, Veradel® PES 3600P, and Udel® PSU P-3703P NT, available from Solvay Specialty Polymers USA, L.L.C. These materials have a number average molecular weight (Mn) greater than 12,000 g/mol, measured by end group analysis as described herein.

Glass fiber: OCV 910A available from Owens Corning.

PPSU, PES, and PSU polymers according to the present invention were prepared from the polymerization of a molar excess of 4,4′-dichlorodiphenyl sulfone with a diphenol (4,4′-biphenol, 4,4′-dihydroxydiphenyl sulfone, and bisphenol A, respectively) in presence of an inorganic base in a solvent as described below. The number average molecular weight (Mn) of each sulfone was determined by end group analysis as described below.

### Preparation of Poly(Aryl Ether Sulfone) (PAES) of the Invention

PPSU #1: PPSU with a Mn of 7550 was prepared according to the following process:

The synthesis of the PPSU was achieved by the reaction in a 4 L reaction kettle of 511.50 g of 4,4′-biphenol (2.747 mol), 835.24 g of 4,4′-dichlorodiphenyl sulfone (2.909 mol) dissolved in a mixture of 2566.69 g of sulfolane with the addition of 410.02 (2.967 mol) of dry K₂CO₃.

The reaction mixture was heated up to 210° C. and maintained at this temperature until the polymer had the expected Mn.

After polymerization is completed, the reaction mixture was cooled to 180° C. and diluted with 1833 g of NMP. The poly(biphenyl ether sulfone) was recovered by filtration of the salts, coagulation, washing and drying.

The end group analysis showed a number average molecular weight (Mn) of 7,550 g/mol.

PES #1: PES with a Mn of 7,500 g/mol prepared according to the following process:

The synthesis of the PES was achieved by the reaction in a 4 L reaction kettle of 380.00 g of 4,4′-dihydroxydiphenyl sulfone (1.518 mol), 468.90 g of 4,4′-dichlorodiphenyl sulfone (1.6223 mol) dissolved in a mixture of 1645.2 g of sulfolane with the addition of 216.13 (1.564 mol) of dry K₂CO₃.

The reaction mixture was heated up to 227° C. and maintained at this temperature until the polymer had the expected Mn.

The poly(ether sulfone) was recovered by filtration of the salts, coagulation, washing and drying.

The end group analysis showed a number average molecular weight (Mn) of 7,550 g/mol.

PES #2: a PES with a Mn of 5,000 g/mol was prepared according to the same process as PES #1, except that 478.47 g of 4,4′-dichlorodiphenyl sulfone (1.666 mol) was used.

PSU #1: a polysulfone (PSU) with a Mn of 7,500 g/mol prepared according to the following process:

The synthesis of the PSU was achieved by the reaction in a 1 L flask of 114.14 g (0.5 mol) of bisphenol A dissolved in a mixture of 247 g of dimethylsulfoxide (DMSO) and 319.6 g of monochlorobenzene (MCB) with an aqueous solution of 79.38 g of sodium hydroxide at 50.34%, followed by distillation of the water to generate a solution of bisphenol A sodium salt free from water by heating the solution up to 140° C. In the reactor was then introduced a solution of 143.59 g (0.5 mol) of 4,4′-dichlorodiphenyl sulfone in 143 g of MCB. The reaction mixture was heated up to 165° C. and maintained at this temperature during 15 to 30 min, until the polymer had the expected Mw.

The reaction mixture was diluted with 400 mL of MCB and then cooled to 120° C. 30 g of methyl chloride was added over 30 min. The polysulfone was recovered by filtration of the salts, washing and drying.

The end group analysis showed a number average molecular weight (Mn) of 7,500 g/mol.

PSU #2: a PSU with a Mn of 4,950 g/mol was prepared according to the same process as PSU #1, except that the reaction was stopped earlier.

### Determination of Number Average Molecular Weight by End Group Analysis Hydroxyl Titration

Hydroxyl groups were analyzed by dissolving a sample of the polymer in 5 ml of sulfolane:monochloro benzene (50:50). 55 ml of methylene chloride was added to the solution and it was titrated with tetrabutyl ammonium hydroxide in toluene potentiometrically using Metrohm Solvotrode electrode & Metrohm 686 Titroprocessor with Metrohm 665 Dosimat. There were three possible equivalence points. The first equivalence point was indicative of strong acid. The second equivalence point was indicative of sulfonic hydroxyls. The third equivalence point was indicative of phenolic hydroxyls. Total hydroxyl numbers are calculated as a sum of phenolic and sulfonic hydroxyls.

### Chlorine Analysis

Chlorine end groups were analyzed using a ThermoGLAS 1200 TOX halogen analyzer. Samples between 1 mg and 10 mg were weighted into a quartz boat and inserted into a heated combustion tube where the sample was burned at 1000° C. in an oxygen stream. The combustion products were passed through concentrated sulfuric acid scrubbers into a titration cell where hydrogen chloride from the combustion process was absorbed in 75% v/v acetic acid. Chloride entering the cell was then titrated with silver ions generated coulometrically. Percent chlorine in the sample was calculated from the integrated current and the sample weight. The resulting percent chlorine value was converted to chlorine end group concentration in micro equivalents per gram.

The concentration of end-groups and respective calculated number average molecular weight (Mn) are listed in Table 1.

TABLE 1
PPSU, PES, and PSU of the Invention

| | —Cl | —OH | Mn |
|---|---|---|---|
| Polymer | (μmol/g) | (μmol/g) | (g/mol) |
| PPSU#1 | 265 | 0 | 7550 |
| PES#1 | 267 | 1 | 7450 |
| PES#2 | 399 | 2 | 5000 |
| PSU#1 | 260 | 7 | 7500 |
| PSU#2 | 381 | 23 | 4950 |

### Preparation of Polymer Compositions

The compositions of the Examples and Comparative Examples are shown below in Tables 2 to 5.

Each formulation was melt compounded using a 26 mm diameter Coperion® ZSK-26 co-rotating partially intermeshing twin screw extruder having an L/D ratio of 48:1. The barrel sections 2 through 12 and the die were heated to set point temperatures as follows:

### Barrels 2-6: 350° C.

### Barrels 7-12: 360° C.

### Die: 360° C.

In each case, the resin blends were fed at barrel section 1 using a gravimetric feeder at throughput rates in the range 30-35 lb/hr. The extruder was operated at screw speeds of around 200 RPM. Vacuum was applied at barrel zone 10 with a vacuum level of about 27 inches of mercury. A single-hole die was used for all the compounds to give a filament approximately 2.6 to 2.7 mm in diameter and the polymer filament exiting the die was cooled in water and fed to the pelletizer to generate pellets approximately 2.7 mm in length. Pellets were dried prior being injection molded.

### Evaluation of Mechanical and Rheological Properties

Mechanical properties were tested for all the formulations using injection molded 0.125 in (3.2 mm) thick ASTM test specimens which consisted of Type I tensile bars.

The following ASTM test methods were employed in evaluating the mechanical properties of the formulations:

D638: Tensile properties
D790: Flexural properties
D256: Izod impact resistance (notched and unnotched)
D3835: Melt viscosity (400° C., 1,000 l/s and 200 l/s) Experimental Results

TABLE 2
PEEK/PPSU Blends With Glass Fibers

| | C1 | 1 | C2 | 2 | C3 | 3 |
|---|---|---|---|---|---|---|
| KetaSpire ® | 65 | 65 | 60 | 60 | 55 | 55 |
| PEEK KT880 | | | | | | |
| Radel ® | 5 | — | 10 | — | 15 | — |
| R-5600 PPSU | | | | | | |
| PPSU#1 | — | 5 | — | 10 | — | 15 |
| Glass fibers | 30 | 30 | 30 | 30 | 30 | 30 |

Melt Viscosity

| | | | | | | |
|---|---|---|---|---|---|---|
| 400° C., | 700.9 | 676.1 | 654.8 | 536.4 | 603.8 | 486.8 |
| 200 sec⁻¹ | | | | | | |
| (Pa · s) | | | | | | |
| 400° C. | 337.0 | 324.4 | 326.4 | 285.6 | 328.7 | 261.4 |
| 1000 sec⁻¹ | | | | | | |
| (Pa · s) | | | | | | |

Mechanical Properties

| | | | | | | |
|---|---|---|---|---|---|---|
| Modulus of | 1600 | 1590 | 1570 | 1600 | 1570 | 1570 |
| Elasticity | | | | | | |
| (ksi) | | | | | | |
| Tensile | 25100 | 25500 | 25000 | 25500 | 24800 | 25300 |
| Strength @ | | | | | | |
| Break (psi) | | | | | | |
| Tensile | 2.7 | 2.7 | 2.8 | 2.7 | 2.8 | 2.7 |
| Elongation @ | | | | | | |
| Break (%) | | | | | | |

As shown above in Table 2, blends of PEEK with PPSU #1 (Mn=7,550 g/mol) in various proportions (Examples 1, 2, and 3) were compared with respective blends of PEEK and commercial PPSU having a higher molecular weight (Comparative Examples C1, C2, and C3). In each case, while the melt viscosities of the blends of Examples 1, 2, and 3 exhibited significantly reduced melt viscosities at both 200 sec⁻¹ and 1000 sec⁻¹ shear rates as compared with Comparative Examples C1, C2, and C3, the mechanical properties of the inventive compositions unexpectedly remained significantly unchanged. For instance, the composition of Example 3 including 15 wt. % of PPSU #1 surprisingly exhibited an approximately 20% reduction in melt viscosity with no significant change in modulus of elasticity, tensile strength at break, or tensile elongation at break.

TABLE 3
PEEK/PES Blends With Glass Fibers

| | C4 | 4A | 4B | C5 | 5A | 5B |
|---|---|---|---|---|---|---|
| KetaSpire ® | 65 | 65 | 65 | 60 | 60 | 60 |
| PEEK KT880 | | | | | | |
| Veradel ® | 5 | — | — | 10 | — | — |
| PES 3600P | | | | | | |
| PES#1 | — | 5 | — | — | 10 | — |
| PES#2 | — | — | 5 | — | — | 10 |
| Glass fiber | 30 | 30 | 30 | 30 | 30 | 30 |

Melt Viscosity

| | | | | | | |
|---|---|---|---|---|---|---|
| 400° C., | 506.8 | 479.8 | 421.5 | 483.4 | 442.1 | 334.4 |
| 200 sec⁻¹ | | | | | | |
| (Pa · s) | | | | | | |
| 400° C., | 306.6 | 288.5 | 228.0 | 290.2 | 263.0 | 165.9 |
| 1000 sec⁻¹ | | | | | | |
| (Pa · s) | | | | | | |

Mechanical Properties

| | | | | | | |
|---|---|---|---|---|---|---|
| Modulus of | 1560 | 1560 | 1550 | 1540 | 1540 | 1590 |
| Elasticity (ksi) | | | | | | |
| Tensile | 24700 | 24700 | 24800 | 24700 | 24600 | 25300 |
| Strength @ | | | | | | |
| Break (psi) | | | | | | |
| Tensile | 3.2 | 3.1 | 2.8 | 3.1 | 3.0 | 2.7 |
| Elongation @ | | | | | | |
| Break (%) | | | | | | |

As shown above in Table 3, blends of PEEK with PES #1 (Mn=7,450 g/mol) or PES #2 (Mn=5,000 g/mol) (Examples 4A, 4B, 5A, and 5B) were compared with respective blends of PEEK and commercial PES having a higher molecular weight (Comparative Examples C4 and C5). In each case, while the melt viscosities of the blends of the inventive Examples exhibited significantly reduced melt viscosities at both 200 sec⁻¹ and 1000 sec⁻¹ shear rates as compared with Comparative Examples C4 and C5, the mechanical properties of the inventive compositions—in particular the modulus of elasticity and tensile strength at break-unexpectedly were significantly unchanged. For instance, the composition of Example 5B including 10 wt. % of the PES #2 (Mn=5,000/g/mol) surprisingly exhibited a decrease in melt viscosity at shear rate 200 sec⁻¹ of 31% and at shear rate 1000 sec⁻¹ of 42% with no significant change in modulus of elasticity or tensile strength at break.

TABLE 4
PEEK/PSU Blends With Glass Fibers

| | C6 | 6A | 6B | C7 | 7A | 7B |
|---|---|---|---|---|---|---|
| KetaSpire ® | 65 | 65 | 65 | 60 | 60 | 60 |
| PEEK KT880 | | | | | | |
| Udel ® | 5 | — | — | 10 | — | — |
| PSU P3703 | | | | | | |
| PSU#1 | — | 5 | — | — | 10 | — |
| PSU#2 | — | — | 5 | — | — | 10 |
| Glass fiber | 30 | 30 | 30 | 30 | 30 | 30 |

Melt Viscosity

| | | | | | | |
|---|---|---|---|---|---|---|
| 400° C., | 541.5 | 526.6 | 457.2 | 533.0 | 522.4 | 439.4 |
| 200 sec⁻¹ | | | | | | |
| (Pa · s) | | | | | | |
| 400° C., | 318.1 | 310.2 | 258.6 | 319.2 | 292.3 | 259.3 |
| 1000 sec⁻¹ | | | | | | |
| (Pa · s) | | | | | | |

Mechanical Properties

| | | | | | | |
|---|---|---|---|---|---|---|
| Modulus of | 1550 | 1570 | 1540 | 1530 | 1600 | 1560 |
| Elasticity (ksi) | | | | | | |
| Tensile | 24900 | 25300 | 24900 | 24500 | 25400 | 25200 |
| Strength @ | | | | | | |
| Break (psi) | | | | | | |
| Tensile | 2.9 | 2.9 | 2.8 | 2.9 | 2.8 | 2.8 |
| Elongation @ | | | | | | |
| Break (%) | | | | | | |

As shown above in Table 4, blends of PEEK with PSU #1 (Mn=7,500 g/mol) and PSU #2 (Mn=4,950 g/mol) (Examples 6A, 6B, 7A, and 7B) were compared with respective blends of PEEK and commercial PSU having a higher molecular weight (Comparative Examples C6 and C7). In each case, while the melt viscosities of the blends of the inventive Examples exhibited reduced melt viscosities at both 200 sec⁻¹ and 1000 sec⁻¹ shear rates as compared with Comparative Examples C6 and C7, the mechanical properties of the inventive compositions unexpectedly were significantly unchanged. For instance, the composition of Example 7B including 10 wt. % of the low molecular weight PSU #2 (Mn=4,950 g/mol) surprisingly exhibited a decrease in melt viscosity at shear rate 200 sec⁻¹ of 18% and at shear rate 1000 sec⁻¹ of 19% with no significant change in the mechanical properties.

TABLE 5
PEEK/PPSU Blends

| | C8 | 8 | C9 | 9 |
|---|---|---|---|---|
| KetaSpire ® | 92.9 | 92.9 | 78.6 | 78.6 |
| PEEK KT820 | | | | |
| Radel ® | 7.1 | | 21.4 | |
| R-5600 | | | | |
| PPSU#1 | | 7.1 | | 21.4 |

Melt Viscosity

| | | | | |
|---|---|---|---|---|
| 400° C., | 393.7 | 369.9 | 357.8 | 308.9 |
| 1000 sec⁻¹ | | | | |
| (Pa · s) | | | | |

Mechanical Properties

| | | | | |
|---|---|---|---|---|
| Modulus of | 518 | 521 | 484 | 492 |
| Elasticity (ksi) | | | | |
| Tensile | 10900 | 11000 | 10900 | 10800 |
| Strength @ | | | | |
| Break (psi) | | | | |
| Tensile | 36 | 38 | 54 | 48 |
| Elongation @ | | | | |
| Break (%) | | | | |

As shown above in Table 5, unfilled blends of PEEK with PPSU #1 (Mn=7,550 g/mol) (Examples 8 and 9) were compared with respective blends of PEEK and commercial PPSU having a higher molecular weight (Comparative Examples C8 and C9). In each case, while the melt viscosities of the blends of the Examples exhibited reduced melt viscosities at 1000 sec⁻¹ shear rates as compared with Comparative Examples C8 and C9, the mechanical properties of the inventive compositions unexpectedly were significantly unchanged. For instance, the composition of Example 9 including 21.4 wt. % of the low molecular weight PPSU (Mn=7550/g/mol) surprisingly exhibited a decrease in melt viscosity at shear rate 1000 sec⁻¹ of 14% with no significant change in the mechanical properties.

1. A polymer composition comprising:
a poly(ether ether ketone) (PEEK),
from 3 to 30 wt. % of a poly(aryl ether sulfone) (PAES), based on the total weight of the poly(ether ether ketone) (PEEK) and the poly(aryl ether sulfone) (PAES),
wherein the poly(aryl ether sulfone) (PAES) has a number average molecular weight (Mn)≤10,000 g/mol, where Mn is calculated by the following formula:
$$Mn = \frac{2 , 000 , 000}{{\sum }_{i} [ {EG}_{i} ]}$$
wherein:
[EGi] is the concentration of end-groups of the PAES in μmol/g.

2. The polymer composition of claim 1, wherein
the poly(ether ether ketone) (PEEK) includes at least 50 mol % of recurring units (R_{PEEK}) of formula: 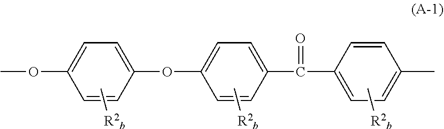
based on the total number of moles of recurring units in the poly(ether ether ketone) (PEEK), wherein:
each R², is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
each b is an integer ranging from 0 to 4.

3. The polymer composition of claim 1, wherein the poly(aryl ether sulfone)(PAES) comprises at least 50 mol % of recurring units (R_{PAES}) of formula: 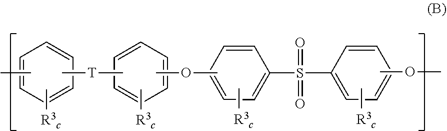
wherein:
each R³, equal to or different from each other, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
each c, equal to or different from each other, is independently selected from 0, 1, 2, 3, and 4; and
T is selected from the group consisting of a bond, a sulfone group [—S(═O)₂], and a group —C(R⁴)(R⁵)—, where R⁴ and R⁵, equal to or different from each other, are independently selected from the group consisting of a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium.

4. The polymer composition of claim 1, wherein the poly(aryl ether sulfone) (PAES) is selected from the group consisting of polysulfone (PSU), polyethersulfone (PES), and polyphenylsulfone (PPSU).

5. The polymer composition of claim 1, wherein the poly(aryl ether sulfone) (PAES) is polyphenylsulfone (PPSU).

6. The polymer composition of claim 1, wherein the number average molecular weight (Mn) of the poly(aryl ether sulfone) (PAES) ranges from about 1,000 to about 10,000 g/mol, wherein Mn is calculated by the following formula:
$$Mn = \frac{2 , 000 , 000}{{\sum }_{i} [ {EG}_{i} ]}$$
wherein:
[EGi] is the concentration of end-groups of the PAES in μmol/g.

7. The polymer composition of claim 1, wherein the polymer composition comprises from about 3 to about 20 wt. % of the poly(aryl ether sulfone) (PAES), based on the total weight of the poly(ether ether ketone) (PEEK) and the poly(aryl ether sulfone) (PAES).

8. The polymer composition of claim 1, further comprising at least one reinforcing filler.

9. The polymer composition of claim 1, wherein the polymer composition comprises:
from about 8 to about 15 wt. % of polyphenylsulfone (PPSU) having a molecular weight ranging from about 5,000 to about 8000 g/mol, wherein Mn is calculated by the following formula:
$$Mn = \frac{2 , 000 , 000}{{\sum }_{i} [ {EG}_{i} ]}$$
wherein [EGi] is the concentration of end-groups of the PAES in μmol/g; and
a glass fiber.

10. A method of making the polymer composition of claim 1, comprising melt mixing the poly(ether ether ketone) (PEEK), the poly(aryl ether sulfone) (PAES), and optionally a reinforcing filler.

11. A shaped article comprising the polymer composition of claim 1.

12. The shaped article of claim 11, wherein the shaped article is part of a mobile electronic device.

13. A method of making the shaped article of claim 11, comprising printing layers of the polymer composition to form the shaped article.

14. The method of claim 13, wherein the layers are printed by selective laser sintering (SLS) or fused filament fabrication (FFF).

15. A filament comprising the polymer composition of claim 1.
